(19) United States
(12) Patent Application Publication
(10) Pub. No.: US 2025/0188209 A1
(43) Pub. Date: Jun. 12, 2025

(54) PHOTOPOLYMER RESIN FORMULATION FOR FABRICATION OF SOLID SILICA GLASS STRUCTURES WITH FEATURE SIZES GREATER THAN 5 MM

(71) Applicant: Lawrence Livermore National Security, LLC, Livermore, CA (US)

(72) Inventors: Johanna Jesse Schwartz, Las Vegas, NV (US); Becca Walton, Castro Valley, CA (US); Dominique Henry Porcincula, Oakland, CA (US); Martin Patrick De Beer, Berkeley, CA (US); Luke Allen Myers, University Park, PA (US)

(21) Appl. No.: 18/919,228

(22) Filed: Oct. 17, 2024

Related U.S. Application Data
(60) Provisional application No. 63/608,061, filed on Dec. 8, 2023.

(51) Int. Cl. C08F 120/28; B33Y 70/10; C03B 19/06; C08F 2/50; C08K 3/36

(52) U.S. Cl. CPC C08F 120/28; B33Y 70/10; C03B 19/06; C08F 2/50; C08K 3/36; C08K 2201/005; C08K 2201/011

(57) ABSTRACT

A resin, in accordance with one aspect of the present invention, includes silica, one or more multifunctional monomers, a solvent for promoting dispersion of the silica in the resin, a dispersing agent, and a photoinitiator. A product, in accordance with one aspect, includes a printed glass part having cross-sectional dimensions, along (imaginary) lines in every direction intersecting a point within the printed glass part, of greater than 5 mm. A process, in accordance with one aspect, includes forming a part from a resin, the resin comprising silica, one or more multifunctional monomers, a solvent for promoting dispersion of the silica in the resin, a dispersing agent, and a photoinitiator. The one or more multifunctional monomers are polymerized to form one or more polymers during and/or after the forming. The formed part is dried. The one or more polymers are removed from the dried part. The dried part is sintered.

### RELATED APPLICATIONS

This application claims priority to Provisional U.S. Appl. No. 63/608,061 filed on Dec. 8, 2023, which is herein incorporated by reference.

This invention was made with Government support under Contract No. DE-AC52-07NA27344 awarded by the United States Department of Energy. The Government has certain rights in the invention.

### FIELD OF THE INVENTION

The present invention relates to photopolymer resins and related products, and more particularly, this invention relates to silica-nanocomposite photopolymer resins that, in some approaches, can allow for parts to be additively manufactured and subsequently post-processed to create dense silica-based products.

### BACKGROUND

The two papers by Kotz et al. listed below are the seminal papers in photopolymer additive manufacturing of glass. Succeeding papers generally utilize derivatives of the formulation outlined in those papers. In these papers, Kotz et. al describe a formulation consisting essentially of 2-hydroxyethylmethacrylate (HEMA), phenoxyethanol (PE), silica, a photoinitiator, and other additives to fabricate various objects with glass.

Kotz, F. et al. Glassomer-Processing Fused Silica Glass Like a Polymer. Adv. Mater. 30, 1707100 (2018).

Kotz, F. et al. Three-dimensional printing of transparent fused silica glass. Nature 544, 337-339 (2017).

Currently, the academic groups associated with Frederik Kotz and Bastien Rapp, as well as their associated company, Glassomer, have a photopolymer resin that includes HEMA, a crosslinker (such as tetraethylene glycol diacrylate (TEGDA) or trimethylpropane triacrylate (TMPTA)), a phenoxyethanol as a dispersing agent, a photoinitiator (such as diphenyl(2,4,6-trimethylbenzoyl) phosphineoxide (TPO)), a silica source, as well as other additives. Derivatives of this formulation were used in various literature after publication of the seminal Glassomer-Processing paper listed above.

Resins made with this formulation have shown great success in fabricating silica parts with photopolymer additive manufacturing, including techniques such as digital light processing (DLP), stereolithography (SLA), and volumetric additive manufacturing (VAM). Broadly speaking, in these processes, parts are fabricated by exposing a photopolymer glass resin to ultraviolet (UV) light, where the liquid glass resin turns from a liquid to a solid upon exposure to UV light. After printing, excess resin is removed and then undergoes a thermal treatment, wherein the more volatile organic components are removed by drying at a low temperature, followed by a pyrolysis step where organic binder material is removed through pyrolysis at higher temperature, and finally followed by sintering of glass particles to create a dense glass part.

In the seminal 2017 and 2018 papers, Kotz et al. were able to fabricate parts via benchtop stereolithography (e.g., using commercial stereolithography printers) and microstereolithography (finer features than benchtop stereolithography), as well as with other conventional subtractive manufacturing techniques. Other efforts have modified this formulation to create formulations with up to 60 wt % silica or include dopants to create colored or luminescent glass. In addition, recent work has also enabled the fabrication of glass parts using the VAM technique.

While some of the glass parts produced with photopolymer additive manufacturing techniques have various dimensions spanning over a centimeter in one dimension or plane, most of the parts do not have thicknesses greater than 1 to 2 millimeters (mm) orthogonal to said dimension or plane, i.e., there is no point in the parts that has a cross sectional thickness or diameter exceeding 5 mm in all directions intersecting said point. In addition, the design rules included with Glassomer photopolymer resins states that there should not be a dimension greater than 5 mm (Glassomer).

Tests conducted with similar resin compositions to form printed parts with dimensions greater than 5 mm generally resulted in part failure (e.g., major cracking) during the drying/debinding process.

Without wishing to be bound by any particular theory, and based on experimentation conducted by the inventors, the inventors presently believe that a limiting factor of the current state of the art formulations is their use of high volumes of HEMA, which is the likely source of failure and/or cracking. The use of HEMA in these formulations is twofold, as it acts as both a dispersant as well as a polymerizable binding agent. However, through experimentation, the inventors have found that, in general, HEMA-based parts with dimensions larger than 5 mm almost invariably fail in the drying/pyrolysis stage, and the final parts are generally unreliable due to internal stresses.

### SUMMARY

A resin, in accordance with one aspect of the present invention, includes silica, one or more multifunctional monomers, a solvent for promoting dispersion of the silica in the resin, a dispersing agent, and a photoinitiator.

A product, in accordance with one aspect of the present invention, includes a printed glass part having cross-sectional dimensions, along (imaginary) lines in every direction intersecting a point within the printed glass part, of greater than 5 mm.

A process, in accordance with one aspect of the present invention, includes forming a part from a resin, the resin comprising silica, one or more multifunctional monomers, a solvent for promoting dispersion of the silica in the resin, a dispersing agent, and a photoinitiator. The one or more multifunctional monomers are polymerized to form one or more polymers during and/or after the forming. The formed part is dried. The one or more polymers are removed from the dried part. The dried part is sintered.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a series of images depicting a ‘Thinker’ statue in its ‘as printed’ stage, dried/debound stage, and sintered stage, in accordance with an exemplary aspect of the present invention.

FIG. 2 depicts compounds usable in various aspects.

FIG. 3 is a schematic of an exemplary, simplified, volumetric additive manufacturing (VAM) apparatus used in conjunction with experimental approaches.

FIG. 4, part a) is an image of sintered cast samples of resins M1-M4 (5 mm scale bar), varying monomer, in accordance with various experimental approaches.

FIG. 4, part b) is an image of resins T1-T3 as-mixed, exemplifying how varying silica results in significantly different rheological properties.

FIG. 4, part c) is an image of sintered cast samples of resins L1-L5 (5 mm scale bar), with varying silica volume loading, in accordance with various experimental approaches. All resulted in pucks with minimal-to-no cracking.

FIG. 4, part d) is an image of photoresins S1-S3 illustrating clarity variation with choice of solvent, in accordance with various experimental approaches.

FIG. 4, part e) is a graph of absorbance vs. wavelength for S1-S3.

FIG. 4, part f) is a graph of percent shrinkage for resins L1-L5 from casting to sintered glass.

FIG. 5 is a chart depicting viscosity as a function of shear rate for 18 vol % OX50, 50 vol % solvent, 32 vol % HDDA resins, in accordance with experimental approaches, illustrating the decreased viscosity of index matched dispersions.

FIG. 6A is a chart illustrating viscosity vs. shear rate for index matched VAM resins with silica loadings from 18 vol % (L1) to 40 vol % (L5), in accordance with experimental approaches.

FIG. 6B. is a chart illustrating viscosity as a function of shear rate for 18 vol % OX50, 50 vol % PC, 32 vol % monomer resins for varying monomers, in accordance with experimental approaches.

FIG. 7, part a) depicts a Rodin Thinker STL model.

FIG. 7, part b) is a volumetric dose map for a horizontal slice through the model shown in FIG. 7 part a).

FIG. 7, part c) is a graph showing volumetric dose distribution among in-part and out-of-part voxels from optimized projection set and storage and loss modulus as a function of volumetric dose.

FIG. 7, part d) shows optical (inverted for clarity) and Schlieren images of gelled model printed using L4 photoresin immediately after print completion.

FIG. 7, part e) is an image of the formed part after rinsing and drying.

FIG. 7, part f) includes images of the part after debinding and sintering, with the picture edited to include photos of both left and right sides of the printed part.

FIG. 8 is a SEM image of an example Cab-O-Sil® EH5 aggregate, in accordance with an experimental approach.

FIG. 9 is a schematic of a Schlieren setup used for monitoring the change in refractive index (RI) of photoresins during curing, in accordance with an experimental approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following disclosure describes silica-nanocomposite photopolymer resins that can allow for parts to be additively manufactured and subsequently post-processed to create dense silica parts. Applications can include glass optics, decorative parts, microfluidic devices, and more.

A resin, in accordance with one aspect of the present invention, includes silica, one or more multifunctional monomers, a solvent for promoting dispersion of the silica in the resin, a dispersing agent, and a photoinitiator.

A product, in accordance with one aspect of the present invention, includes a printed glass part having cross-sectional dimensions, along (imaginary) lines in every direction intersecting a point within the printed glass part, of greater than 5 mm.

A process, in accordance with one aspect of the present invention, includes forming a part from a resin, the resin comprising silica, one or more multifunctional monomers, a solvent for promoting dispersion of the silica in the resin, a dispersing agent, and a photoinitiator. The one or more multifunctional monomers are polymerized to form one or more polymers during and/or after the forming. The formed part is dried. The one or more polymers are removed from the dried part. The dried part is sintered.

### Silica-Glass Loaded Photopolymer Resins

Various aspects of the present invention include optimized photopolymer glass formulations that allow for fabrication of solid glass products (also referred to herein as ‘parts’) with a smallest cross-sectional feature size greater than 5 mm as measured at some point therein.

In various approaches, formulations may be tuned for use in any of a plurality of photopolymer additive manufacturing techniques, such as SLA, DLP, VAM, and two photon polymerization (2PP).

Formulations of silica-glass loaded photopolymer resins (referred to herein as ‘resins’), according to various approaches, include two components not found in prior art formulations, which allow for the printing of green bodies and their subsequent thermal processing to enable formation of dense, optical quality silica glass. The two components include one or more multifunctional monomers, and a preferably non-reactive, low vapor pressure solvent system that promotes good dispersion of silica in a silica-glass loaded photopolymer resin (referred from herein as ‘resin’). In general, a vapor pressure below <0.1 mm Hg at 25 C may be considered a low vapor pressure in various approaches described herein. The monomer and solvent system are preferably index-matched to the silica to enable optical clarity in the resins. When the various components are combined in the proper proportions, green bodies with cross sectional areas in the range of hundreds of square millimeters to square centimeters (or more) can be printed for creating products with specific features sizes with dimensions greater than 5 mm measured at some point in the part after sintering, and preferably with specific features sizes dimensions greater than about 10 mm measured at some point in the part after sintering, and in some aspects greater than about 50 mm measured at some point in the part after sintering, without cracks in the part.

As noted above, the inventors have found that, in general, HEMA-based parts with dimensions larger than 5 mm almost invariably fail in the drying/pyrolysis stage, and the final parts are generally unreliable due to internal stresses.

To overcome this, the formulations in accordance with one aspect of the present invention exclude the use of HEMA entirely, i.e., the resins have no HEMA therein. Instead, inventive resins described herein, in accordance with various approaches, utilize two different components to assist with dispersion and acting as a binding system. The inventive resin formulation, as exemplified by the exemplary approach listed in Table 1, includes silica, a dispersing agent, and a photoinitiator, but also uses a dispersing solvent, and a multifunctional monomer as the binding agent, rather than HEMA.

TABLE 1
Exemplary silica resin formulation.

| | Vol % relative to total volume of resin, |
|---|---|
| | including any sub-range of vol % values |
| | within the stated range (noting that |
| | some approaches may use higher or |
| Component | lower amounts than those listed here) |
| Silica | About 10 to about 50, preferably about 15 |
| | to about 42 |
| Multifunctional monomer | About 15 to about 50, preferably about 20 |
| | to about 35 |
| Dispersing solvent | Up to about 50. Actual amount may |
| (solvent system of one | depend on vol % of selected |
| or more solvents) | multifunctional monomer and refractive |
| | index of silica, as discussed below. The |
| | ratio of monomer:(solvent + dispersing |
| | agent) preferably does not exceed 4:1. |
| Dispersing agent | Up to about 14.5 |
| Photoinitiator | Effective amount to enable curing |
| Other additives (optional) | Up to about 15 |

The silica may be any suitable conventional silica. Exemplary silicas include Aerosil OX50 sold by Evonik Corporation having a sales office at 299 Jefferson Road, Parsippany, NJ, USA; etc. Fumed silicas work well. The silica is ideally amorphous to assist with glass formation. Silicas having a relatively lower surface area per unit mass are preferred as this lends to the inclusion of more silica into the ink which in turn increases the green part strength, as well as improves the size of part that can be successfully processed without cracking. Regarding particle sizes, any particle size distribution is acceptable, with an average particle size above 20 nm being preferred, and an average particle size above 35 nm being more preferred. Preferably, the average particle size is below about 100 nm, but could be higher in some implementations. In addition, the higher the purity of the silica, the better, e.g., because higher purity silica enables optical quality glass, whereas the presence of impurities might enable a glass part to be printed and processed, but of an optical quality not suitable for optical purposes.

The dispersing agent, preferably present in an effective amount to aid in dispersion, may be any suitable conventional dispersing agent. Exemplary dispersing agents include phenoxyethanol (PE), etc. Other additives may include poly(vinyl pyrrolidone), poly(vinyl alcohol), Triton X-100, Darvan C, sodium dodecyl sulfate, and others. The ratio of dispersing agent to solvent may be adjusted to cause the overall refractive index of the resin to about match the refractive index of the silica, e.g., the respective refractive indices are within 10% of one another, preferably within 5% of one another, and ideally within 2% of one another, as calculated using conventional techniques.

The photoinitiator, preferably present in an effective amount to enable curing, may be any suitable conventional photoinitiator. Exemplary photoinitiators include TPO, TPO-L, phenylbis(2,4,6-trimethylbenzoyl) phosphineoxide (BAPO), 2,2-Dimethoxy-2-phenylacetophenone (DMPA), etc.

One or more other additives of known type may be added to the resin, if desired, in an effective amount to provide a desired benefit imparted by the additive. Exemplary additives include a photoinhibitor/polymerization inhibitor to slow curing and print outgrowth, such as hydroquinone, 4-methoxyphenol (MEHQ), 2,2,6,6-tetramethyl-1-piperinyloxyl (TEMPO), etc.; colorant such as a dye; diethyl phthalate; UV absorber such as TINUVIN® 1130, photoabsorber, etc.; nanoparticles such as silver nanoparticles, gold nanoparticles, germania nanoparticles, titania nanoparticles, etc. to affect the optical qualities of the glass; opacifiers; clarifiers; etc. In a preferred approach, TEMPO is added to slow the polymerization process and make the resin less sensitive to oxygen concentration gradients. The effective amount of TEMPO may be between approximately 0.00685 volume % and 0.00343 volume % of the final resin, but could be present in a higher or lower concentration.

The dispersing solvent (solvent) may be any solvent that would become apparent to one skilled in the art after reading the present disclosure. The dispersing solvent is preferably present in an effective amount to provide the desired level of dispersion.

A preferred dispersing solvent is propylene carbonate (PC), but may also and/or alternatively include other moieties, such as tetraethylene glycol dimethyl ether (tetraglyme). Dispersing solvents with smaller polar molecules may be preferred to obtain lower viscosity as well as to avoid formation of a yield stress paste. Accordingly, polar solvents with a boiling point of 200° C. or higher are preferred. Other characteristics of preferred dispersing solvents are that they are miscible, and nonreactive, with the other components of the resin. Also preferred are non-chain molecules; accordingly, preferred solvents consist essentially of or consist of non-chain molecules.

Various approaches may use a polar solvent of almost any type, so long as it is not in a chain configuration, has a boiling point preferably above about 200° C. (but could be lower in some cases), is miscible with the multifunctional monomer and dispersing agent, and is inert when the multifunctional monomer is reacting.

The dispersing solvent preferably has a relatively low volatility to slow evaporation thereof. This may also improve structural integrity, e.g., by preventing evaporation of too much solvent from the outer portion of a structure formed from the resin, while some dispersing solvent remains inside the structure where it can create stress. Moreover, a dispersing solvent that burns out cleanly is preferred.

Some candidate dispersing solvents are not particularly preferred, but may be used in some approaches. For example, tetraglyme did not work well in experiments because, while it worked well for processing, it tended to raise viscosity above desired levels. Organic compounds containing a hydroxyl group may also be used, though alcohols may prematurely terminate the polymerization process.

The dispersing solvent is preferably present with the dispersing agent, the photoinitiator, and the multifunctional monomer to aid in dispersing the silica in order to create a flowable resin (rather than a paste). The amount of dispersing solvent may be selected based on the desired concentration of multifunctional monomer. The ratio of solvent to dispersing agent may be selected to cause the overall refractive index of the resin to about match the refractive index of the silica.

PC is notable as a dispersing agent due to its low vapor pressure (and consequently high boiling point), which allows the part to dry at a slower, more controlled rate versus higher vapor pressure solvents that, through rapid evaporation, can cause damage to the part. However, while PC is an excellent option as a dispersing agent, its difference in refractive index from silica can cause cloudiness in resins. In applications where optical clarity (e.g., at least 80% transparency) in the resin is preferred, such as in volumetric additive manufacturing, where pathlengths of a few centimeters are required, PC may be mixed in an appropriate ratio with another agent such as PE and the monomer to index match to the silica, resulting in a transparent resin. The proper ratio for index matching may be determined by one skilled in the art via routine experimentation, based on the teachings herein.

The binding system is based on one or more multifunctional monomers of any suitable type that would become apparent to one skilled in the art after reading the present disclosure. Preferred multifunctional monomers include acrylate/methacrylate monomers, such as 1,6-hexanedioldiacrylate (HDDA), trimethylpropane triacrylate (TMPTA), poly(ethylene glycol) diacrylate (PEGDA, also known as polyethylene glycol diacrylate), pentaerythritol tetra acrylate (PETA), and others. In some approaches, the multifunctional monomer includes one or more types of bifunctional acrylate monomers. In further approaches, the multifunctional monomer includes one or more types of trifunctional acrylate monomers, though such monomers may result in higher shrinkage which in turn results in increased internal stresses within the final product, relative to otherwise identical products formed with bifunctional monomers. Further approaches may include multifunctional thiols. Yet other approaches may include multifunctional silicones. Thus, the binding system does not rely on HEMA, noting however that small amounts of HEMA may be added to the resin along with the aforementioned multifunctional monomer(s) in nonpreferred approaches.

In general, the refractive index of the resin changes with concentration of multifunctional monomer, thereby allowing matching of the overall refractive index of the resin to the refractive index of the silica. Note that in general, too high of a concentration of multifunctional monomer may cause cracking of the final part. Without wishing to be bound by any particular theory, it is believed that solvent may become trapped within the structure, causing cracking. Also, in general, too low a concentration of multifunctional monomer may result in a part that is too weak, as exemplified by a propensity for breakage during drying.

Utilizing a multifunctional acrylate as a binding system creates a stiff part comprised of a stable polymer-network morphology, whereas HEMA as a binding system per the prior art results in a polymer morphology consisting of intertwined linear polymer chains of which there may be significant variation in molecular weight that may affect the thermal processing and generally result in failure of the printed part. Without wishing to be bound by any theory, the inventors presently surmise that the molecular weight distribution of photopolymerized HEMA may result in both long chain polymers as well as dimers, trimers, and other small oligomers. These dimers, trimers, and oligomers may have different evaporative or debinding energies that may cause failure in the drying and debinding stages, thus leading to failure in printed parts.

One surprising discovery during experimentation was that monofunctional monomers in the resin were able to be printed in VAM, but failed in debinding. This was unexpected because monofunctional monomers generally worked well in direct ink writing (DIW) processes. However, in products formed with VAM, high rates of breakage were seen during thermal processing, currently theorized to be due to formation of a weaker acrylate network.

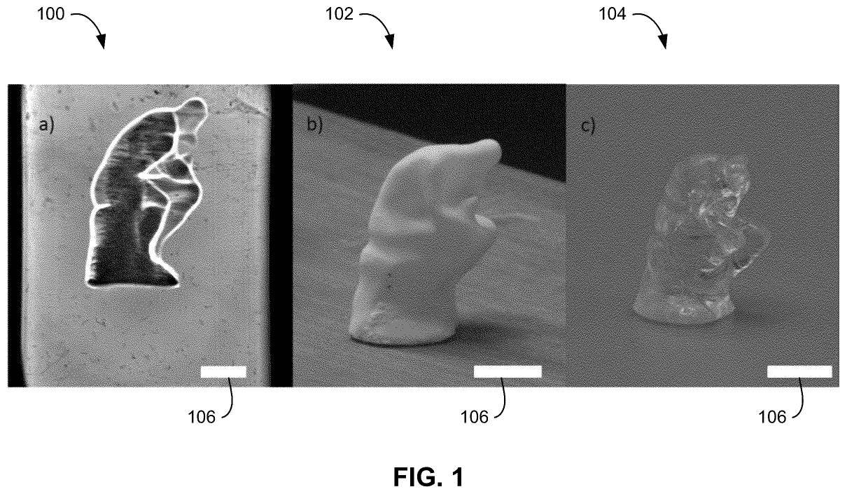

FIG. 1 depicts an example of a ‘Thinker’ statue in its ‘as printed’ stage 100, dried/debound stage 102, and sintered stage 104. The scale bars 106 represent approximately 5 mm. The base of the Thinker as printed, shown in part a) measures approximately 1 cm in its longest dimensions, which translates to approximately 6.3 mm when sintered, as shown in part c), demonstrating that parts with dimensions larger than 1 cm can be printed and sintered to completion without failure.

The resulting resin formulation with a low vapor pressure solvent (such as PC) and multifunctional monomer (such as HDDA) replacing HEMA enables photopolymerization of parts that allow for a minimum cross-sectional dimension intersecting some point therein of greater than 5 mm, which enables larger parts with greater design flexibility. Such minimum cross-sectional dimension may be the shortest length of any of the lengths measured along imaginary lines that intersect said point and extend linearly in every direction. Said another way, at that point in the part, there is no dimension, in any direction intersecting said point, that is shorter than the minimum cross-sectional dimension.

It must be noted that, while this resin formulation represents an advance in printed glass towards achieving dimensions in the realm of a few cubic centimeters, this resin formulation does not represent a lower bound for printed glass dimensions. Based on the inventors' current understanding and processing conditions, this resin would not necessarily be, but could be, suitable for printing tens of centimeters or liter-sized quantities of material with or without further modification or adjustment of processing parameters.

The minimum (smallest) cross-sectional feature size greater than 5 mm as measured at some point in a part after sintering means that, at some point within the part, there is no dimension of the part between outer surfaces thereof, in any direction along imaginary lines intersecting the point in all directions, which is less than 5 mm. To be clear, a part may have some points where the minimum feature size is less than 5 mm, but there is at least one point in the part where the minimum feature size is greater than 5 mm as measured along lines intersecting that point and extending in in all directions to the outer surface of the part. The minimum feature size is preferably determined at a location, within the formed part after sintering, where no distance between outer surfaces of the part in any direction from the point of cross section is less than 5 mm. For example, in a part having a rectangular cross section, the minimum feature size at some point therein would be the smallest dimension in any direction from or through that point, e.g., along the x, y and z axes of the rectangular part. In another example, a part having a circular or oval cross section and an elongated longitudinal axis, the minimum feature size at some point would be the minimum diameter taken perpendicular to the longitudinal axis. In yet another example, a part having a conical shape with a cone length greater than its maximum diameter would have a minimum feature size, at a point in the plane of greatest diameter (measured perpendicular to a longitudinal axis of the cone), equaling the maximum diameter.

Table 2 depicts an illustrative silica resin formulation. This formulation is provided by way of example only to demonstrate a working approach.

TABLE 2
Exemplary 35 vol % silica resin formulation.

| | Vol % relative to |
|---|---|
| Component | total volume of resin |
| Silica (Aerosil OX50) | 35 |
| Multifunctional monomer (HDDA) | 25.4 |
| Solvent (Propylene Carbonate) | 25.3 |
| Dispersing agent (Phenoxyethanol) | 14.3 |
| Photoinitiator (TPO-L) | 0.017 |

Here, PC is added with phenoxyethanol, the photoinitiator, and the multifunctional monomer to aid in dispersing the silica in order to create a flowable resin (rather than a paste).

### Processing of Resins

Another aspect of the present invention involves the processing of the new silica-glass loaded photopolymer resins of the types disclosed herein. In one exemplary process, the resin is printed in a photopolymer process (e.g. with SLA, DLP, VAM, etc.), where application of light (e.g., UV light) transforms portions of the resin, or all of the resin, into a solid. Excess resin may be removed via any appropriate technique (e.g., washing, blowing with compressed gas, centrifuging, centrifugal spinning, etc.), after which the part is dried at a temperature effective to allow and/or promote drying of the part (e.g., at a temperature in the range of room temperature to about 150° C., more preferably at a temperature in the range of 80° C. to 120° C., preferably at approximately 100° C.); debound at a temperature effective to debound the material (e.g., at a temperature in the range from a minimum effective temperature to debound the material to about 800° C., preferably at about 600° C.±80° C.) whereby polymeric binder is or may be removed, e.g., through pyrolysis; and then sintered at a temperature effective to sinter the remaining material (e.g., at a temperature in the range from a minimum effective temperature to sinter the material to about 1600° C., preferably at about 1400° C.±100° C.) to form a dense, transparent silica-based glass part. The processing of the as-printed part through drying, debinding, and sintering can cause a large amount of shrinkage in the part, sometimes as large as 50% or more.

Any photocuring technique suitable for the particular resin formulation may be used. For example UV curing may be performed. Likewise, curing with wavelengths outside the UV range, or including UV and other light, may be performed. The extent of photocuring may be selected per the manufacturer's preference, with more curing generally corresponding to a stiffer product.

In one approach, crosslinking is performed by depositing the resin on a desired substrate and subjecting the deposited film to photocuring. Photocuring may be achieved by placing the deposited film under a curing lamp, and exposing the resin with light from the lamp for a desired period of time. The structure thus formed may be a glass film, protective coating, cast part, etc.

In another approach, photo-crosslinking may be performed to create products in other forms. For example, the resin may be cured in a 3D mold. In another approach, the resin may be cured in droplet form to create beads and particles. In a further approach, the resin may be applied as a coating material or shell layer for protection and/or encapsulation purposes.

In further aspects, the resin, before curing, may be used as a feedstock and/or starting material for 3D printing, spraying, painting, glass-forming inks, etc.

In various approaches, resins described herein may be used as “inks” in additive manufacturing (AM) processes to form the inventive concepts described herein. Such “inks” (and singular forms thereof) may be used interchangeably and refer to a composition of matter (resin) in liquid phase such that the composition of matter may be “written,” extruded, printed, or otherwise deposited to form a layer that substantially retains its as-deposited geometry and shape with perhaps some, but preferably not excessive, sagging, slumping, or other deformation, even when deposited onto other layers of ink, and/or when other layers of ink are deposited onto the layer. Preferably, a stack of filaments or layers of extruded ink is self-supporting, e.g., substantially retains its as-printed shape with minimal sagging, slumping, or other deformation. As such, skilled artisans will understand the presently described inks to exhibit appropriate rheological properties to allow the formation of monolithic structures via deposition of multiple layers of the ink (or in some cases multiple inks with different compositions) in sequence.

Illustrative AM processes that may be used to print such inks include DIW, extrusion freeform fabrication, and other equivalent techniques. Resulting products formed thereby exhibit unique structural and compositional characteristics conveyed via the precise control allowed by such techniques. The physical characteristics of a structure formed by DIW may include having lower layers of the structure that are slightly flattened, slightly disfigured from original extrusion, etc. due to weight of upper layers of the structure formed thereabove, due to gravity, etc. A three-dimensional structure formed by DIW may have a single continuous filament that makes up at least two layers of the 3D structure.

Additional AM techniques include photo polymerization processes, e.g., projection micro-stereolithography (PuSL), photolithography, two photon polymerization, etc., or other equivalent techniques. Resulting products formed thereby exhibit unique structural and compositional characteristics conveyed via the precise control allowed by such techniques. The physical characteristics of a structure formed by photo polymerization processes may include fabrication of a solid micro-structure having complex geometric arrangement of ligaments, filaments, etc. The formation of a three-dimensional structure includes exposing a resin having the mixture to light, where a pattern in the photoresist is created by the exposing light.

According to one inventive aspect, a 3D structure formed from the mixture has physical characteristics of formation by AM. In one approach, direct-ink-writing (DIW) affords the possibility of creating fine physical features (<1 mm) with single and multicomponent features not attainable by standard polymer casting methods. In one approach, a 3D structure may have a physical property of being rigid and the cured extruded continuous filament forms a uniquely-shaped structure. A uniquely-shaped structure may be any structure that does not have a conventional shape (e.g., cube, cylinder, molded shape, etc.). In some approaches, a shape of a uniquely-shaped structure may be defined by a user, a computer program, etc.

In some approaches, the architectural features of the formed 3D parts may have length scales defined by specific AM techniques. For example, portions of the features of a part may have length scales in a range between 0.1 micron (μm) to greater than 100 μm, depending on the limitations of the AM techniques. In various approaches, AM techniques provide control of printing features, ligaments, etc. of 3D structures having length scales in a range between 0.1 μm to greater than 100 μm, and ultimately, by forming many layers, a minimum cross-sectional dimension of greater than 5 mm at some point in the part. Further, a photocurable functionality lends itself to light-driven AM techniques, including PuSL and direct laser writing via two photon polymerization (DLW-TPP). Stereolithography-based AM techniques are notable for high throughput, fine features, and detailed prototyping. Even higher resolution can be achieved with DLW-TPP, which can produce ligaments on the order of 100 nm.

The printed or formed part, prior to consolidation (shrinking) may have a minimum feature size at some point therein of about 10 cm or greater, e.g., a printed cube of 10 cm×10 cm×10 cm. The final product then, after shrinkage, may have a minimum feature size at some point therein of about 6 cm or greater, e.g., a glass cube of about 5 cm×5 cm×5 cm, a glass cube of about 6 cm×6 cm×6 cm, and so on.

In addition, compositional gradients may be incorporated into various parts. Note that where the target structure is to have regions with different compositions, different inks may be used to create each region and/or a gradient in composition. Alternatively, the composition of the slurry being jetted may be changed over time to allow formation of a gradient in composition in the structure. In at least some approaches, a gradient may be formed between the two regions of the transparent ceramic such that there is a gradual shift in composition of the material in the transparent ceramic. In other approaches, the transitions are sharp.

Similarly, structural gradients may be incorporated into various parts by controlling the extent of curing at different locations within the part.

### In Use

Resins described herein, such as the silica-nanocomposite photopolymer resins listed above and below, may be used in additive manufacturing processes such as stereolithography, digital light processing, volumetric additive manufacturing, and other techniques and subsequently post-processed to create dense silica parts and other glass-containing products such as glass optics, decorative parts, microfluidic devices, packaging, etc.

### Experimental

This section describes experiments conducted and the results thereof, and is presented by way of example only and should not be deemed limiting in any way.

Additive manufacturing of glass aims to change the paradigm of glass manufacturing by allowing for improved customization coupled with lower energy and post-processing needs. Fabrication of glass via VAM involves printing in a silica-loaded photopolymer resin with subsequent thermal processing and adds additional advantages by allowing for rapid printing of parts with smooth surfaces and no supports. Previous work in glass VAM has demonstrated fabrication of optical quality microoptics with overall dimensions on the scale of tens of cubic millimeters. For applications requiring glass printed on the scale of cubic centimeters the rheology, scattering, and green part strength may be controlled via resin formulation. This section presents insight into a novel glass photopolymer resin suitable for VAM and the effect that tuning formulations has on the ability to produce dense glass parts with volumes on the scale of cubic centimeters.

### 1. Introduction

Silica glass is an important and ubiquitous material prized for high transparency, heat resistance, and chemical inertness with essential applications in optics, coatings, electronics, and building materials. Despite widespread use, methods for mass production of glass have largely remained unchanged since the industrial revolution. Generally, glass fabrication involves time- and energy-intensive processing steps, including melting glass, molding to a desired shape, and annealing slowly as the glass cools. For optics applications, annealed blanks of glass should be machined and polished to intensive specifications, further adding to fabrication complexity and time.

Advances in additive manufacturing (AM) have aimed to create an alternative method to manufacture glass, as AM can potentially eliminate or reduce molding and machining steps by making complex geometries directly. Glass AM includes both direct and indirect methods for generating glass structures. Direct methods may utilize selective laser sintering to consolidate glass powders or high temperature extrusion to melt and deposit glass rods. The downsides to direct glass AM and traditional manufacturing stem from the need for high refractory materials to withstand fabrication heats, high costs from equipment and processing, and industrialization difficulties associated with low production volumes. Indirect methods avoid these downsides, as they generate glass through first creating composite structures of organic components and nano-scale glass particles. Once printed, the structure is subsequently thermally processed to remove the organic components and sinter the silica particles together. Additionally, some indirect SLA approaches generate glass or ceramics during pyrolysis of inorganic precursors or preceramic polymers within the photoresin (resin).

Indirect glass AM methods include techniques such as direct ink write (DIW), stereolithography (SLA), digital light processing (DLP) AM, and two photon polymerization (2PP). Efforts in the field of DIW glass have produced several promising results, including optical quality single composition glass and multimaterial gradient refractive index (GRIN) glass. Other efforts in photopolymer techniques, such as SLA, DLP AM and 2PP, have allowed for fabrication of parts with sub-micron and microscale features.

Various kinds of nanoparticle silicas have been reported in literature for indirect AM of glass, including Cab-O-Sil® EH5 and Aerosil® OX50. These have all generally found success in conversion of parts from green bodies to dense silica glass, with resin rheology and volume loading highly dependent on silica particle size and surface area. In all of these cases, it is critical that the initial glass particles are amorphous to obtain a transparent sintered glass, and therefore to date, it has been found that particles should be sub-100 nm.

In addition to the layer-based indirect AM methods noted above, modification of a commercial photopolymer glass resin has enabled fabrication of glass via layer-free VAM. VAM is an attractive technique for glass fabrication as it is a layer-free technique that enables rapid, freeform fabrication of parts with smooth surfaces and without the need for support. Previous work in VAM of glass focused on fabrication of microoptics, but glass VAM prints in excess of 4 mm have heretofore not been demonstrated. In addition, an examination of the effects of different formulation components on printability or processing into dense glass has not been shown in literature, limiting customizability.

Design of a photopolymer resin suitable for VAM of glass requires balancing optical, rheological, printing, and thermal processing properties needed to ensure that a part will print with intended geometric accuracy and survive thermal processing of the printed green body to a sintered glass part. Optically, VAM resins should be lowly absorbing and non-scattering at the wavelength of irradiation to enable proper volumetric energy dosage control within the print volume. This may require index matching of the various components in particle-filled resins, in addition to tuning of photoinitiator concentration to allow for suitable light penetration and bulk curing kinetics.

Rheologically, it is desirable for resins to have a yield stress to minimize part mobility, such as sinking or rising via polymerization-induced thermal convection or print densification. Additionally, the ideal viscosity should preferably be low enough for facile degassing of bubbles, post-print processing and excess uncured resin removal.

Lastly, subsequent thermal post-processing of the printed green body should sinter the part to transparent glass while maintaining part fidelity with minimal cracking or surface defects.

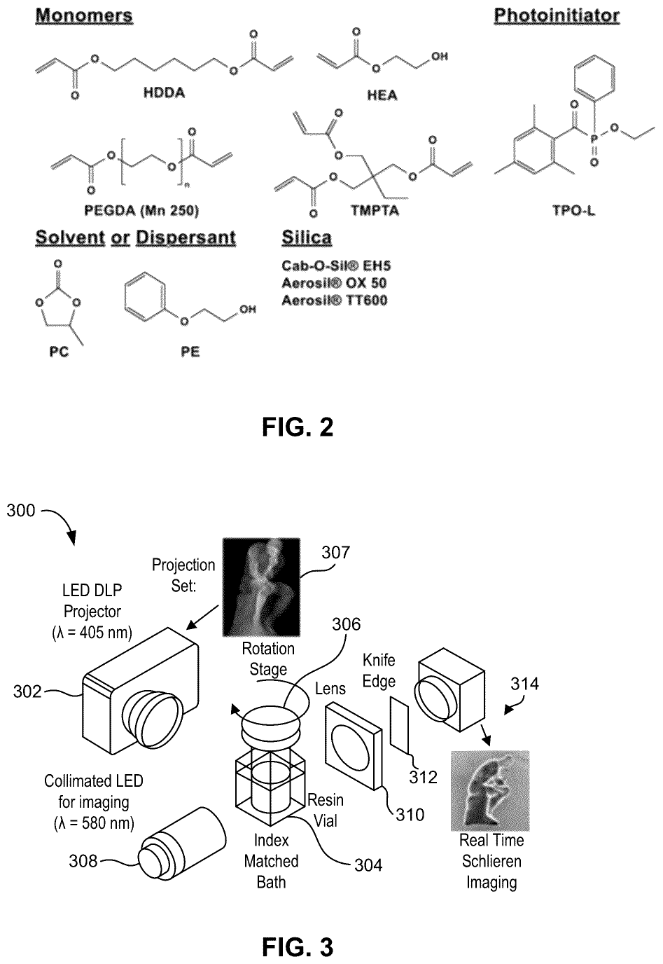

Hereinbelow are presented results of the inventors' investigation of a custom formulation space comparing different monomers, silicas, and solvents and their impacts on the optical and rheological properties of the photoresin, bulk photopolymerization kinetics, and print composite thermal processing. Among these components are three different types of nanoparticle silica, including Cabosil® EH5, Aerosil® TT600, and Aerosil® OX50; four different monomers varying acrylate functionality, including 2-hydroxyethyl acrylate (HEA), 1,6-hexanediol diacrylate (HDDA), polyethylene glycol diacrylate (PEGDA, Mn 250), and trimethylolpropane triacrylate (TMPTA); and two different dispersing solvents and mixtures thereof, including propylene carbonate (PC) and phenoxyethanol (PE), as shown in FIG. 2. When tuned properly, these formulation parameters enable parts to be printed with dimensions greater than 5 mm, which presents the largest volumetrically printed glass parts to date.

Table 3 shows all formulations screened in this study.

TABLE 3
Formulations of ink investigated in the experiments and their
associated identifiers. Each formulation also includes 0.01 g/L TPO-L
photoinitiator. M2, T2, and S1 are the same resin and S2 and L1
are the same resin. In total, 12 formulations were studied.
Monomer Series - 18 vol % silica, 50 vol % PC

| Identifier | Monomer type | Monomer vol % |
|---|---|---|
| M1 | HEA | 32 |
| M2 | HDDA | 32 |
| M3 | PEGDA | 32 |
| M4 | TMPTA | 32 |

Silica Type Series-32 vol % HDDA, 50 vol % PC

| Identifier | Silica type | Silica vol % | Silica surface area (m²/g) |
|---|---|---|---|
| T1 | EH5 | 18 | 380 |
| T2 | OX50 | 18 | 50 |
| T3 | TT600 | 18 | 200 |

Solvent Series - 18 vol % OX50 silica, 32 vol % HDDA

| Identifier | vol % PC | vol % PE |
|---|---|---|
| S1 | 50 | 0 |
| S2 | 32 | 18 |
| S3 | 0 | 50 |

Silica Loading Series

| Identifier | vol % OX50 | vol % HDDA | vol % PC | vol % PE |
|---|---|---|---|---|
| L1 | 18 | 32 | 32 | 18 |
| L2 | 25 | 29 | 29 | 16 |
| L3 | 30 | 27 | 27 | 15 |
| L4 | 35 | 25 | 25 | 14 |
| L5 | 40 | 23 | 23 | 13 |

### 2. Experimental Methods

### Materials and General Considerations

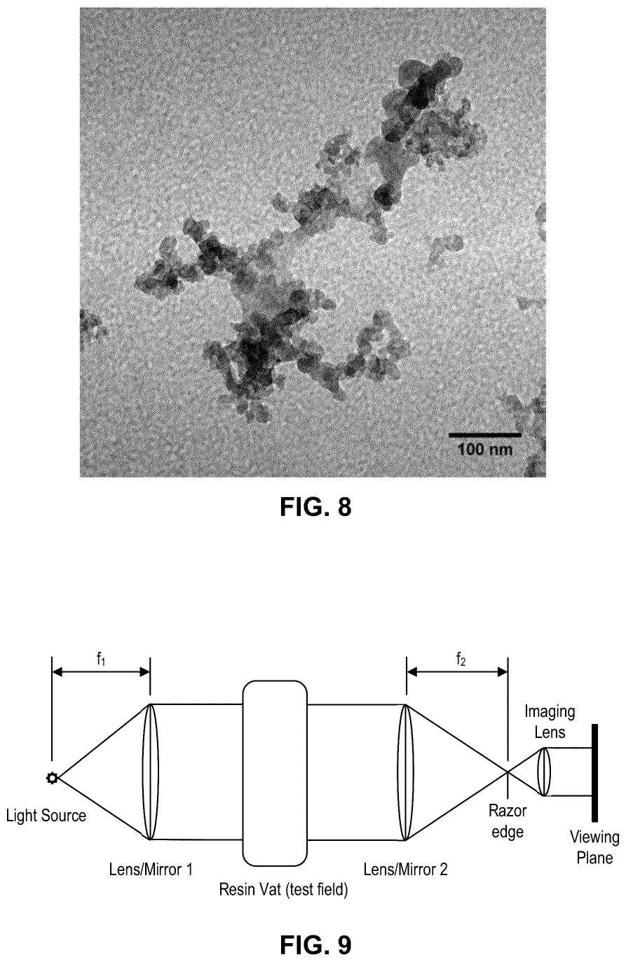

1,6-hexanediol diacrylate (HDDA, technical grade, 80%), polyethylene glycol diacrylate (PEGDA, Mn 250), 2-hydroxyethyl acrylate (HEA), trimethylolpropane triacrylate (TMPTA), propylene carbonate (PC), phenoxyethanol (PE), and (2,2,6,6-tetramethylpiperidin-1-yl)oxyl (TEMPO) were purchased from Sigma Aldrich. Cab-O-Sil® EH5 (22 nm, 380 m²/g) fumed silica was provided by Cabot, and Aerosil® OX50 (40 nm, 50 m²/g), and Aerosil® TT600 (70 nm, 200 m²/g) fumed silica sources were provided by Evonik. Cab-O-Sil® EH5 fumed silica particles form roughly 100 nm aggregates, as determined by scanning electron microscopy (see FIG. 8, discussed below). Genocure TPO-L (2,4,6-trimethylbenzoyldi-phenylphosphinate) was provided by Rahn USA. All materials were used as received without any further purification.

### Resin Preparation and Bulk Casting

To prepare each resin, each organic component was measured by weight with the exception of the photoinitiator which was pipetted volumetrically from a stock solution of the photo-initiator and one of the other organic components at a concentration of 0.01 g/ml. Fumed silica was added by weight to the organics and mixed in a Thinky Planetary Centrifugal Mixer for 2 minutes, followed by manually scraping down the sides of the Thinky cup to ensure full incorporation before mixing for an additional 2 minutes under vacuum in a Thinky Vacuum Mixer to remove bubbles. The resin was then poured into a VAM vial and left in a drawer overnight to allow oxygen to diffuse back into the resin. Formulations were screened for thermal processing survival by casting resin into a cylindrical puck (20 mm, 10 mm, or 4 mm in diameter, and 5 mm depth) and photocuring in nitrogen within a UV photobox (Strategic 3D Solutions helix cure 60) for 20 minutes.

### Volumetric Additive Manufacturing

FIG. 3 is a schematic of an exemplary, simplified, volumetric additive manufacturing (VAM) apparatus 300 used for the present experiments.

VAM prints were performed in a custom printer setup equipped with a 405 nm LED light engine (3DLP9000, Digital Light Innovations) 302, with a telecentric lens (PlatinumTL 62-914, 0.5X, 28.7 mm, Edmund Optics) and maximum intensity of 52 mW cm 2 at the imaging plane (measured using a Thorlabs PM100D with S120C detector). The digital micromirror device (DMD, DLP9000 Texas Instruments) has 2560×1800 pixels with a calculated pixel size of 14 μm at the projected image plane resulting in a projected image size of ˜35.8×25.2 mm. A 26.5 mm ID glass shell vial (60965D-120, DWK Life Sciences) 304 was mounted with a custom fixture to a rotational stage (HDR50, ThorLabs) 306, and all prints were done using projection sets calculated to deliver 50 mJ cm⁻³ at a rotation rate of 35 degree/s. Projection sets 307 were generated to deliver an integer fraction of the gelation dose (measured with UV-rheology) using a previously described gradient descent minimization algorithm. During printing, gelation was monitored with red light Schlieren imaging 314 perpendicular to the 405 nm projection optical path. The Schlieren imaging path includes a collimated LED (M625L3) 308, the index-matching bath, resin vat, a set of lenses 310 to focus light onto a camera CCD at the viewing plane, and a knife edge 312 for enhanced contrast. A quartz container (Reflex Analytical Corporation) with index matching fluid (a mixture PC and PE matched to the RI589 nm of uncured resin, RI˜1.46) was used to minimize the cylindrical distortion of the vial on printing. Printed parts were removed from the vial and rinsed three times with propylene carbonate to remove unreacted resin and UV post-cured under nitrogen for 20 minutes.

### Thermal Processing

After either casting or printing and washing, parts were dried by ramping to 100° C. at a rate of 0.1° C./min and dwelling for 5 days. The polymer binder was removed by heating to 190° C., then 250° C., and finally 600° C. at a rate 0.1° C./min with 12 hour dwells at each temperature. The part was sintered by ramping from room temperature to 1400° C. at a rate of 10° C./min.

### Rheology

Shear rate sweeps were performed on a TA Instruments DHR-1 rheometer with a UV attachment using a 20 mm aluminum top plate and a 20 mm quartz bottom plate and a gap of 0.2 mm. Samples were equilibrated at an oscillation of 0.001% strain at a 1 Hz frequency for 20 minutes after loading into the rheometer, followed by a ramp from 0.001 s⁻¹ to 100 s⁻¹.

### UV-Rheology

A light guide (S2000, Omnicure) fitted with a 405 nm filter was used for illumination. Samples were irradiated between a 20 mm aluminum top plate and 20 mm acrylic bottom plate, with a 0.1 mm gap. The light intensity was measured prior to each experiment. Oscillatory motion was applied in the linear viscoelastic regime at a 1% strain with an angular frequency of 10 rad s⁻¹ for up to 360 s. Oscillatory motion was conducted in the dark for the first 30 s, followed by illumination for the remaining time. To account for reflection off the top plate, we use the following formula when calculating volumetric dose:

$${E}_{vol , Rheo} = \frac{{I}_{0} r ( {e}^{- α {z}_{t}} - 1 )}{{z}_{t}} ( 1 + {e}^{- α {z}_{t}} ) t$$

Where E_{vol,Rheo} is the volumetric dose, I₀ is the incident light intensity through the bottom plate, r is the reflectivity of the top plate (typically assumed to be 0.9), α is the attenuation coefficient, zₜ is the thickness of the sample, and t is the exposure time.

### Absorbance

Absorbance values were determined by loading resin into a 1 cm pathlength cuvette and measured using a Shimadzu UV-vis spectrometer.

### Refractive Index

Refractive index (RI) was measured using an Anton Paar Abbemat MW. Measurements were taken at wavelengths between 436.3 nm and 655.3 nm and fit to Cauchy's equation to extrapolate RI at 405 nm.

### 3. Results and Discussion

Choice of monomer in VAM of glass impacts the photoresin viscosity, reactivity, curing shrinkage, and organic burn-out. Four acrylate-based monomers: HEA, HDDA, PEGDA, and TMPTA were evaluated based on these factors. Photoresins with comparable compositions and weight loadings of dispersant, monomer, and silica were first made, changing only the monomer composition (Table 3, M1-M4). Photoresins M1-M4 exhibited similar curing times, between about 50 and 60 s (Table 4, S1, meaning that cure time was not a factor for consideration in down-selecting monomers for further characterization. It is important to note that the stock bottle of HEA used here was not purified prior to use, and contains diacrylate impurities, which may contribute to the similar bulk curing kinetics. Additionally, little difference was measured in the viscosity of M1-M4, with photoresin M4 being marginally higher at 50 Pa·s while M1-M3 were approximately 15-22 Pa·s, all compared at shear rate of 0.1 s⁻¹.

TABLE 4
Gelation times for resins with varying monomer functionality . . .

| Monomer Type | Gelation Time (s) | Standard Deviation (s) |
|---|---|---|
| HEA | 61.9 | 2.6 |
| HDDA | 51.4 | 0.9 |
| TMPTA | 58.2 | 0.4 |

Because of the slightly higher molecular weight of TMPTA in comparison to the other screened acrylates, this difference is not surprising. As the viscosity is expected to increase significantly with increased loadings of silica nanoparticles, TMPTA was excluded for further testing. In this way, photoresins that could have as high loadings of silica possible prior to reaching a practical VAM viscosity limit, were carried forward.

To compare resins prior to VAM printing, the inventors believed that it was important to compare the sintering of bulk cast parts with diameters larger in size than the end target goal of greater than 5 mm. This is because in the inventors' studies, small features had a higher success rate of sintering to completion, but in large parts cracking and defects became more prominent. To address this, resins were compared by producing bulk cast cylindrical pucks of 4 mm, 10 mm, and 20 mm in diameter for each of the tested resins. These pucks were processed in the same way as the VAM printed samples, as described in the experimental methods.

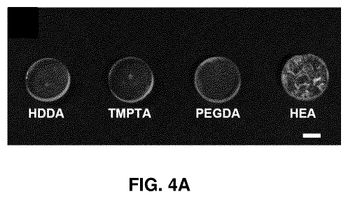

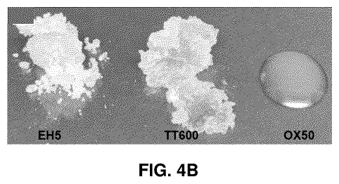

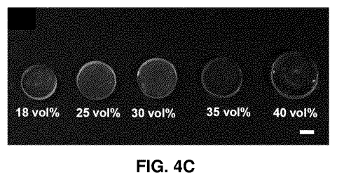

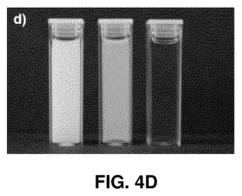

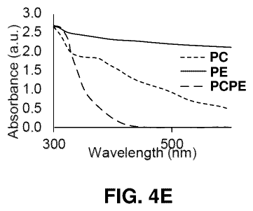

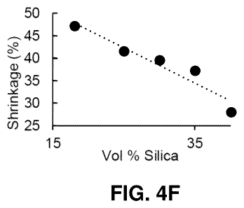

The results are shown in FIG. 4. Part a) of FIG. 4 depicts sintered cast samples of resins M1-M4 (5 mm scale bar), varying monomer. Part b) shows resins T1-T3 as-mixed, exemplifying how varying silica results in significantly different rheological properties. Part c) depicts sintered cast samples of resins L1-L5 (5 mm scale bar), with varying silica volume loading. All resulted in pucks with minimal-to-no cracking. Part d) depicts photoresins S1-S3 illustrating clarity variation with choice of solvent. Part e) is a corresponding graph of absorbance vs. wavelength for S1-S3. Part f) is a chart depicting percent shrinkage for resins L1-L5 from casting to sintered glass.

Observing the quality and extent of cracking in the largest pucks provided the most insight into the potential success or failure of our VAM printed parts. Despite similar cure times and viscosities, the thermal processing of photoresins M1-M4 differ, as seen in FIG. 4, part a). M1, the HEA-based sample, exhibited significant cracking, making it unsuitable as a monomer choice. Without wishing to be bound by any theory, it is presently surmised that this may be because of the softer, viscoelastic network of cured HEA in comparison to the stiffer multifunctional acrylate networks. Because HEA is above its glass transition temperature at room temperature, it may lead to instabilities in the composite structure that lead to cracking in the sintered part visible in FIG. 4, part a). M2-M4 all produced pucks with minor surface defects, but no significant cracking. To explore silica and dispersant effects, the inventors continued their exploratory study using M2, an HDDA-based photoresin.

While high surface area silica was found to be suitable for applications of DIW of glass, it was found that low surface area silica, such as OX50, suited the VAM photoresins better. As seen in FIG. 4, part b), for a base resin formulation of 32 vol % HDDA, 50 vol % PC, and 18 vol % silica, higher surface area silicas were generally not able to form flowable resins, instead resulting in a powder, as was the case with EH5 (T1), or a highly viscous paste, as was the case with TT600 (T3) neither of which could be characterized with the rheometer. The comparatively lower surface area OX50 resulted in a low viscosity flowable resin (22 Pa·s at 0.1 s⁻¹). A decrease in viscosity with decreasing specific surface area is in line with the literature and indicates the importance of balancing small, amorphous particles for proper glass formation upon sintering, with as low a specific surface area as possible to achieve a low yield stress fluid for VAM.

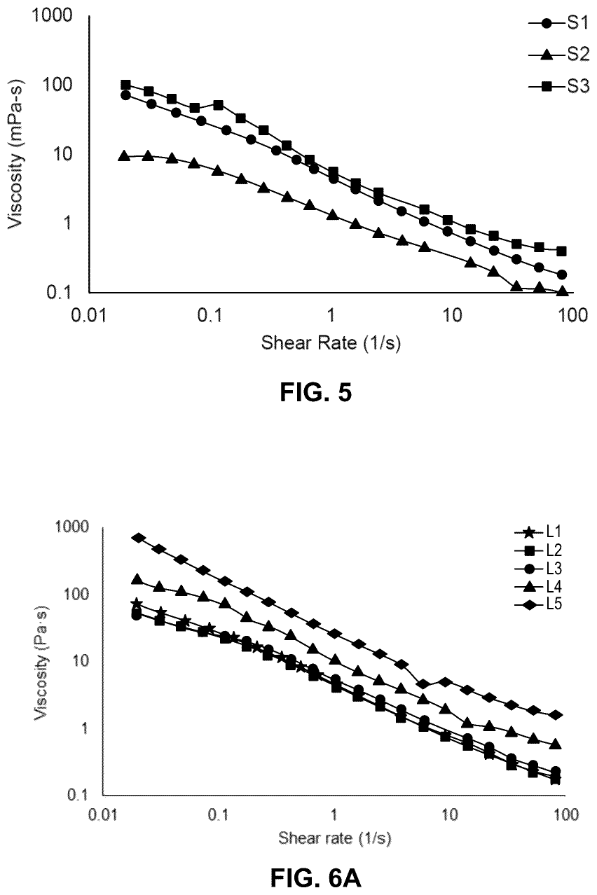

Selecting a solvent is also crucial in the resin design process. Propylene carbonate and phenoxyethanol were chosen for screening because of their use in previous research as suitable solvating and dispersing agents. Measurements of photoresins S1-3 at 0.1 s⁻¹ showed viscosities of 10, 6, and 50 Pa*s respectively (FIG. 5), indicating that the index-matched mixture S2 of PC and PE is most effective at suspending the silica particles as it had reduced viscosity. This is because a solvent-particle system with closely matched dielectric constants, which dictates RI, will display lower magnitude van der Waals forces, thus reducing agglomeration and lowering viscosity.

FIG. 4, parts d) and e) show photoresin S2 was significantly more transparent than S1 and S3, and pucks cast with resins S1 and S3 cracked during drying and debinding. With S2 showing good clarity and part survival, this solvent system was selected for further silica loading screenings.

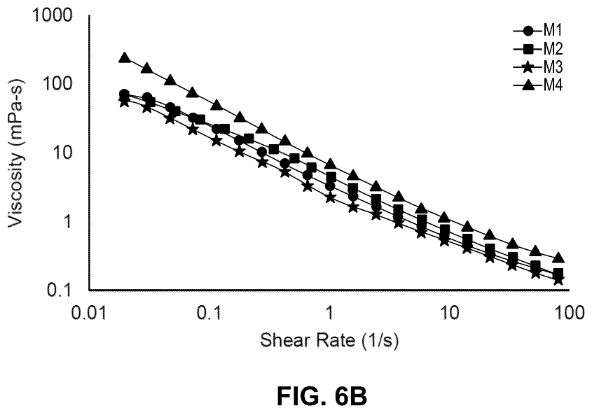

With monomers, solvent, and silica chosen to minimize cracking, we wanted to tune shrinkage and identify the limits of printability for VAM resins with varying silica loading, L1-L5. The initial tests and resins were conducted with 18 vol % silica to be significantly above the ˜10-16 vol % percolation threshold for spherical nanoparticles, which was expected to lead to more robust green parts as the print would be composed of a continuous particle network. The clarity of each resin in this series (L1-L5) was comparable due to an index matched PC/PE/HDDA mixture. For resins L1-L3 the viscosity at 0.1 s⁻¹ was approximately 22 Pa·s, and overall each resin had similar behavior at higher shear rates. See FIGS. 6A, 6B.

Resins L4 and L5 displayed higher viscosities at 0.1 s⁻¹ at approximately 70 and 160 Pa·s respectively. Despite these differences in viscosity, resins L1-L5 were all found to be suitable for VAM printing and part removal from the uncured resin. Each resin in this series also survived thermal processing to sinter into a transparent glass, but due to the different silica loadings, displayed differing amounts of shrinkage from print to glass (FIG. 4, parts c) and f)). Therefore, silica loading can be used as a feature for designed shrinkage, as parts will shrink between 28-47% based on the silica loading, which can be accounted for in part design and used to fabricate glass geometries with feature sizes smaller than what is printable with the VAM technique.

While L1-L5 all produce effective sintered glass end use objects, for VAM printing L4 resin was chosen to simultaneously minimize viscosity and shrinkage. This resin, containing 35 vol % OX50, 32 vol % HDDA, 32 vol % PC, 18 vol % PE, and 1 mM TPO-L, enabled rapid fabrication of parts, facile processing, and minimal shrinkage.

A summary of the comparisons of the resins tested is as follows:

L1-L5 and S2 exhibited excellent optical clarity and were produced in 20 mm diameter pucks with minimal-to-no cracking. L4 was chosen for VAM printing.

M1 and S3 exhibited optical clarity issues as well as significant cracking.

M2, M3, M4, T2 and S1 exhibited optical clarity issues but were produced in 20 mm diameter pucks with minimal-to-no cracking.

T1 and T3 were viscous pastes or powder upon mixing, and were not able to be tested.

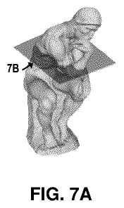

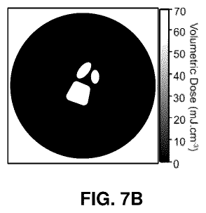

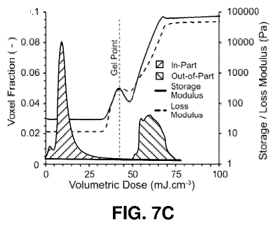

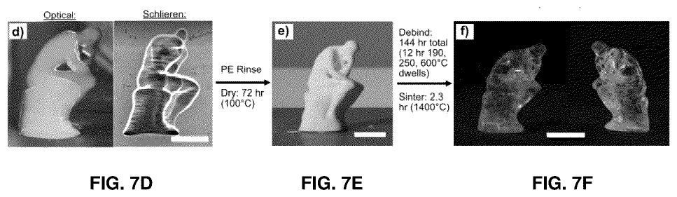

Fabrication of dense glass objects was demonstrated using tomographic VAM. Printing with L4 resin as formulated for bulk cast samples initially produced structures with some surface cracking. As previously reported in VAM polymer and glass printing literature, TEMPO was found to improve print resolution and fidelity, and reduce surface cracking. Without wishing to be bound by any theory, it appears that TEMPO slows the polymerization process and makes the resin less sensitive to oxygen concentration gradients. For this reason, 0.25 mM TEMPO (with respect to the overall liquid volume) was added for prints, resulting in observation of surface cracking improvements. A ˜15 mm tall Rodin's Thinker was chosen as an exemplary model to demonstrate the fabrication process, which is generally depicted in FIG. 7. Particularly, FIG. 7, part a) depicts a Rodin Thinker STL model. Part b) depicts a volumetric dose map for a horizontal slice through the model shown in part a). Part c) is a graph showing volumetric dose distribution among in-part and out-of-part voxels from optimized projection set and storage and loss modulus as a function of volumetric dose. Part d) are optical (inverted for clarity) and Schlieren images of gelled model printed using L4 photoresin immediately after print completion. Part e) depicts the formed part after rinsing and drying. Part f) depicts the part after debinding and sintering, with the picture edited to include photos of both left and right sides of the printed part. All scale bars are 5 mm.

A surface mesh of the model, or STL file, (shown in FIG. 7 part a) was input to a gradient descent minimization algorithm to give a series of angular projection patterns. A cross-section of these projections is visible in FIG. 7 part b). During printing, these patterns were projected into the rotating vial and light energy was selectively delivered to desired regions.

In FIG. 7 part c), it is seen that volumetric doses in excess of 50 mJ/cm³ are selectively delivered to interior, or ‘in-part’ voxels, while exterior, or ‘out-of-part’, voxels typically have less than 20 mJ/cm³. This creates the requisite contrast for three-dimensional patterning of the gelled material. Binning voxels by their delivered dose and segregating them into ‘in-part’ or ‘out-of-part’ is a convenient way to visualize the contrast between the ‘in-part’ and ‘out-of-part’ regions (FIG. 7, part c)). Using photorheology experiments, where the storage and loss modulus are measured as a function of delivered dose (or exposure), the volumetric dose required to gel the photopolymer can be determined. Here we find that the gelation dose for L4, defined as the point where the storage and loss modulus cross, is approximately 45 mJ/cm³. In our tomographic method, we can scale the magnitude (or grayscale values) of the projections such that the gelation dose lies between the in-part and out-of-part regions on the dose distribution (shown by the dotted line in FIG. 7, part c)). This ensures that the entire geometry is formed after an integer number of rotations.

Successful VAM printing of the optimized resin is achieved and optical and Schlieren imaging of the final part still suspended in the vial are shown in FIG. 7 part d). When sintered, the resulting Thinker had final dimensions of 12.0 mm×5.6 mm×6.7 mm, which to our knowledge, is larger than any previously reported VAM printed glass structure. The structure exhibited a 28% shrinkage from printed green body to final glass part.

An interesting result of printing with a formulation composed of index-matched dispersions, is that the change in RI upon polymerization of the monomer causes a stark RI mismatch and significant scattering-causing the gelled part to appear opaque after printing. The impact of heating during curing, and this RI mismatch was also obviously visible by Schlieren imaging during VAM printing. See FIG. 8, which is a SEM image of an example Cab-O-Sil® EH5 aggregate. Particles measure 22 nm, with aggregates ranging up to 500 nm are visible. See also FIG. 9, which is a schematic of a Schlieren setup used for monitoring the change in refractive index (RI) of photoresins during curing. Setup was placed perpendicular to irradiation path (VAM projection would pass through the page) to enable real-time monitoring. The labeling on FIG. 9 is self-explanatory, noting that f₁ and f₂ refer to the respective focal length.

After printing, parts were rinsed in PC to remove any residual uncured resin on the surface, post-cured with UV, and dried to remove volatile liquid components still present in the part (FIG. 7, part e). Removal of the low temperature volatile components prior to the debinding step is currently believed to be crucial to obtaining large parts without cracking. The crosslinked photopolymer was finally removed in a debinding process. The temperature was ramped and held at 190, 250, 600° C. for 12 h each at a rate of 0.1° C./min to gradually remove organic components that burn close to those temperatures, after which the part was completely silica powder. Finally, the temperature was ramped at 10° C./min to a sufficiently high temperature (1400° C.) for the glass nanoparticles to sinter together while still maintaining the desired shape and transparency.

Lastly, we were interested to see if the comparative results of our silica and solvent screenings in HDDA-based resins could be translatable to the other monomers that our initial screenings had shown good bulk cast sintering results. With this in mind, we also printed PEGDA-based Thinker structures, containing 35 vol % OX50 and index-matched PC and PE, and saw good printability and sintering to transparent glass.

### 4. CONCLUSION

Design of a glass photopolymer resin suitable for VAM glass structures with cross-sectional diameters greater than 5 mm requires a balance of optical resin properties, printability, and thermal processing. By comparing bulk cast pucks, measuring viscosity, UV photorheology, and index matching resins through solvent control, the inventors have discovered a facile way to reliably identify silica-containing photoresins that lead to successful VAM parts. Overall, small diacrylate monomers seem to be suited for glass VAM, and other monomers may be suitable as well. As validated in this study, lower specific surface area nanoparticles tend to result in a lower viscosity resin that is suitable for VAM printing and processing. With this in mind, a preferred silica source may have sub-100 nm particle size, and specific surface area around 50 m²/g. Solvent/dispersant systems work best when index matched to the silica particles, as this results in better dispersion and higher clarity for printing. Finally, if the monomers, silica specific surface area, and solvent/dispersant system are robust enough, then the relative volume of silica can be tailored to produce predictable amounts of shrinkage, with higher loadings being favorable for larger printed parts.

The inventive concepts disclosed herein have been presented by way of example to illustrate the myriad features thereof in a plurality of illustrative scenarios, approaches, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various aspects have been described above, it should be understood that they have been presented by way of example only, and not limitation. Thus, the breadth and scope of an aspect of the present invention should not be limited by any of the above-described exemplary approaches, but should be defined only in accordance with the following claims and their equivalents.

What is claimed is:

1. A resin, comprising:
silica;
one or more multifunctional monomers;
a solvent for promoting dispersion of the silica in the resin;
a dispersing agent; and
a photoinitiator.

2. The resin as recited in claim 1, wherein the solvent is nonreactive with all components of the resin.

3. The resin as recited in claim 1, wherein the one or more multifunctional monomers and solvent are index-matched to the silica.

4. The resin as recited in claim 1, wherein no 2-hydroxyethylmethacrylate (HEMA) is present in the resin.

5. The resin as recited in claim 1, wherein the silica is present in the resin at about 10 to about 50 vol % based on a total volume of the resin.

6. The resin as recited in claim 1, wherein the one or more multifunctional monomers is present in the resin at about 15 to about 50 vol % based on a total volume of the resin.

7. The resin as recited in claim 1, wherein the solvent is present in the resin up to about 50 vol % based on a total volume of the resin.

8. The resin as recited in claim 1, wherein the dispersing agent is present in the resin at about 14 vol % based on a total volume of the resin.

9. The resin as recited in claim 1, wherein a ratio of dispersing agent to solvent is at a value that causes an overall refractive index of the resin to about match a refractive index of the silica.

10. The resin as recited in claim 1, further comprising an additive selected from the group consisting of: a photoinhibitor, a polymerization inhibitor, a colorant, diethyl phthalate, a UV absorber, nanoparticles, an opacifiers, and a clarifier.

11. The resin as recited in claim 1, wherein the solvent is a polar solvent with a boiling point of at least about 200° C.

12. The resin as recited in claim 1, wherein the solvent consists essentially of non-chain molecules.

13. The resin as recited in claim 1, wherein the one or more multifunctional monomers are selected from the group consisting of: acrylate monomers and methacrylate monomers.

14. The resin as recited in claim 1, wherein an overall refractive index of the resin about matches a refractive index of the silica.

15. The resin as recited in claim 1, wherein the resin is physically printable using a process selected from the group consisting of: digital light processing (DLP), stereolithography (SLA), and volumetric additive manufacturing (VAM) and two photon polymerization (2PP).

16. A product, comprising:
a printed glass part having cross-sectional dimensions, along lines in every direction intersecting a point within the printed glass part, of greater than 5 mm.

17. The product as recited in claim 16, wherein the minimum cross-sectional dimensions are at least 10 mm.

18. The product as recited in claim 16, wherein the minimum cross-sectional dimensions are at least 50 mm.

19. A process, comprising:
forming a part from a resin, the resin comprising silica, one or more multifunctional monomers, a solvent for promoting dispersion of the silica in the resin, a dispersing agent, and a photoinitiator, wherein the one or more multifunctional monomers are polymerized to form one or more polymers during and/or after the forming;
drying the formed part;
removing the one or more polymers from the dried part; and
sintering the dried part.

20. The process as recited in claim 19, wherein the forming includes a printing technique selected from the group consisting of: digital light processing (DLP), stereolithography (SLA), and volumetric additive manufacturing (VAM) and two photon polymerization (2PP).

21. The process as recited in claim 19, wherein the sintered part has at least one point therein with dimensions of greater than 5 mm in all directions intersecting the point.
